(19) United States
(12) Patent Application Publication
(10) Pub. No.: US 2025/0200685 A1
(43) Pub. Date: Jun. 19, 2025

(54) Methods and Systems for Identifying Vehicles of Interest

(71) Applicant: ZF Friedrichshafen AG, Friedrichshafen (DE)

(72) Inventors: Matthew Jazwiecki, Canton, MI (US); William Frigon, Novi, MI (US); Pulkit Monga, Westland, MI (US); Srinivas Mysore, Novi, MI (US); David Wilson, Milford, MI (US); Grigory Yezersky, Farmington Hills, MI (US)

(21) Appl. No.: 18/540,000

(22) Filed: Dec. 14, 2023

(51) Int. Cl. G06Q 50/26

(52) U.S. Cl. CPC G06Q 50/26

(57) ABSTRACT

A method for identifying a vehicle of interest includes: accessing data corresponding to a vehicle of interest alert; accessing data from a sensor corresponding to images of one or more other vehicles; computing, with a machine-learned model, a vehicle of interest match estimate for the one or more other vehicles based at least in part on the data from the sensor; and computing a vehicle of interest identification.

### TECHNICAL FIELD

The present subject matter relates generally to systems and methods for identifying vehicles of interest.

### BACKGROUND

A vehicle of interest alert can be issued by law enforcement agencies to facilitate investigations. For example, an amber alert can be issued during a potential child abduction. The vehicle of interest alerts may include a description of a vehicle of interest that allows the public to report potential sightings of the vehicle of interest to law enforcement agencies.

Vehicle of interest alerts frequently result in false positive sightings, in which members of the public report sightings of vehicles that do not correspond to the vehicle of interest. In addition, communicating the vehicle of interest alert to a large portion of the public can be difficult. Thus, vehicle of interest alerts can have low reliability. Further, while looking for the vehicle of interest, drivers may be distracted.

Accordingly, improved systems and methods for identifying vehicles of interest would be useful.

### BRIEF DESCRIPTION

In general, the present subject matter is directed to systems and methods for detecting vehicles of interest. For instance, a computing device onboard a vehicle may access a vehicle of interest alert, which may correspond to a vehicle description provided by a law enforcement agency. The vehicle of interest alert may include one or more of a make, model, color, license plate number, number of passengers, age of passengers, and other identifying information for the vehicle of interest. One or more sensors on the vehicle may be configured for capturing images of other vehicles operating nearby the vehicle. In an example arrangement, the sensors may include a camera (such as a front ADAS camera, a rear backup camera, a side-view camera, etc.) that capture images of the other vehicles. A machine-learned model may analyze the images from the sensor to detect a vehicle of interest match estimate for the other vehicles operating nearby the vehicle. For example, the machine-learned model may be trained to detect the make, model, color, license plate number, number of passengers, age of passengers, and other characteristics of the other vehicle in the images. When a match to the vehicle of interest is identified, a vehicle of interest identification may be computed. The vehicle of interest identification may include the make, model, color, license plate number, number of passengers, age of passengers, and other characteristics of the other vehicle that matches the vehicle of interest. The vehicle of interest identification may also include an image of other vehicle that matches the vehicle of interest and/or travel data for the other vehicle that matches the vehicle of interest, such as location, direction of travel, speed, etc. The vehicle of interest identification may be transmitted to the law enforcement agency to assist with the vehicle of interest search.

As may be seen from the above, vehicles may advantageously assist with the vehicle of interest search, e.g., while driving normally. Moreover, in example arrangements, a machine-learned model may automatically identify the vehicle of interest based at least in part on images of other vehicles taken by vehicle sensors. Thus, vehicle of interest alerts can be more reliable and safer than conventional approaches.

Aspects and advantages of the disclosure will be set forth in part in the following description, or may be apparent from the description, or may be learned through practice.

In an example arrangement, A method for identifying a vehicle of interest includes: accessing, with a computing device on a vehicle, data corresponding to a vehicle of interest alert; accessing, with the computing device, data from a sensor corresponding to images of one or more other vehicles; computing, with a machine-learned model on the computing device, a vehicle of interest match estimate for the one or more other vehicles based at least in part on the data from the sensor; computing, with the computing device, a vehicle of interest identification in response to the vehicle of interest match estimate exceeding a threshold level; and transmitting, with the computing device, data corresponding to the vehicle of interest identification to a remote computing device that is located outside the vehicle.

In another example arrangement, a system for identifying a vehicle of interest includes: a vehicle; a sensor located on the vehicle; one or more processors located onboard the vehicle; and one or more non-transitory computer-readable media that store instructions that are executable by the one or more processors to perform operations. The operations include: accessing data corresponding to a vehicle of interest alert; accessing data from the sensor corresponding to images of one or more other vehicles; computing, with a machine-learned model, a vehicle of interest match estimate for the one or more other vehicles based at least in part on the data from the sensor; computing a vehicle of interest identification in response to the vehicle of interest match estimate exceeding a threshold level; and transmitting data corresponding to the vehicle of interest identification to a remote computing device that is located outside the vehicle.

These and other features, aspects and advantages of the present disclosure will become better understood with reference to the following description and appended claims. The accompanying drawings, which are incorporated in and constitute a part of this specification, illustrate arrangements of the disclosure and, together with the description, serve to explain the principles of the disclosure.

### BRIEF DESCRIPTION OF THE DRAWINGS

An enabling disclosure of the present disclosure, directed to one of ordinary skill in the art, is set forth in the specification, which makes reference to the appended figures.

FIG. 1 is a side, elevation view of a passenger vehicle according to an example arrangement of the present subject matter.

FIG. 2 is a schematic view of a drivetrain of the example vehicle of FIG. 1.

FIG. 3 is a schematic view of an example control system of the vehicle of FIG. 1 according to an example arrangement of the present subject matter.

FIG. 4 is a block diagram view of certain components of a vehicle of interest identification system according to an example arrangement of the present subject matter.

FIG. 5 is a schematic view of vehicle of interest identification systems according to an example arrangement of the present subject matter.

FIG. 6 is a flow diagram of a method for identifying vehicles of interest according to an example arrangement of the present subject matter.

### DETAILED DESCRIPTION

Reference now will be made in detail to arrangements of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one arrangement can be used with another arrangement to yield a still further arrangement. Thus, it is intended that the present disclosure covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

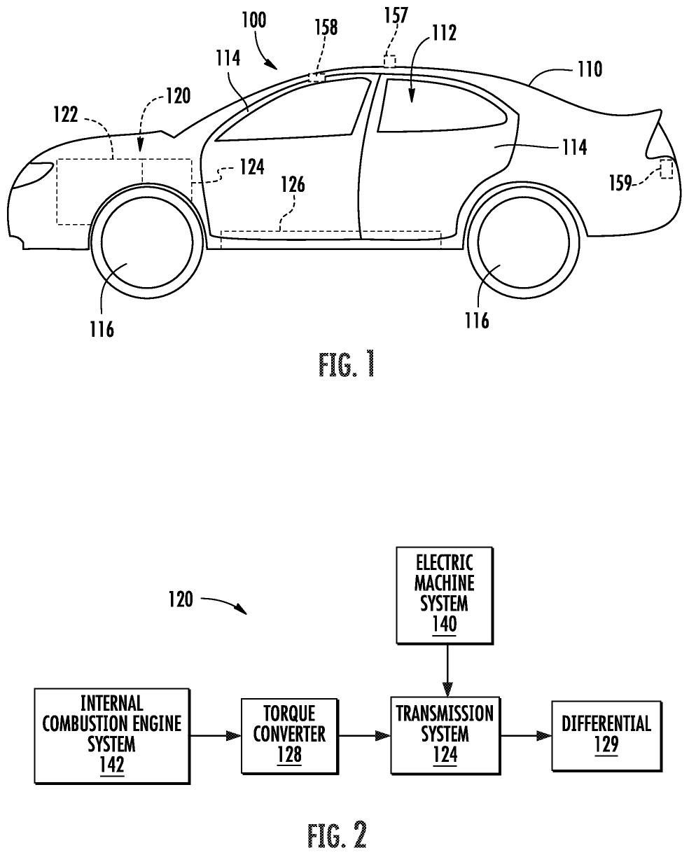

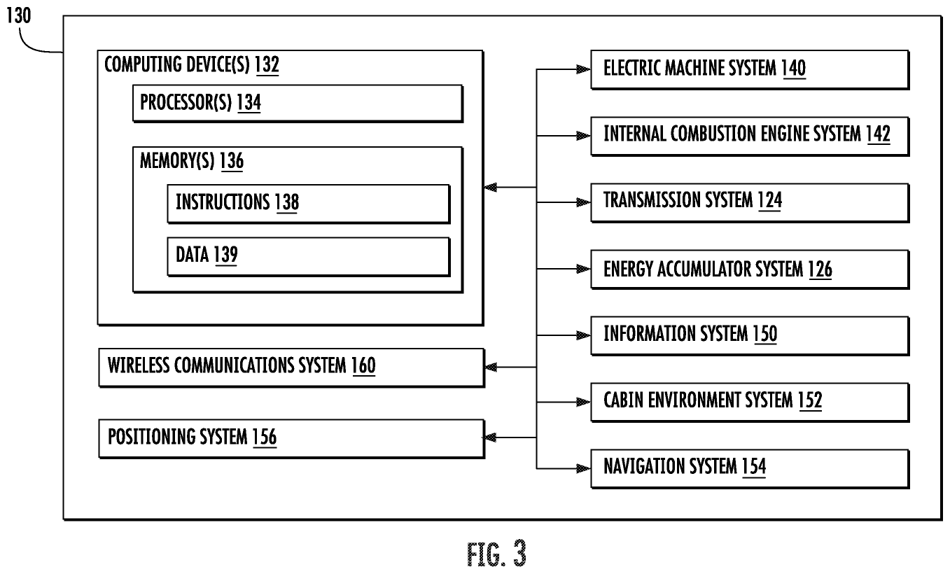

FIG. 1 is a side, elevation view of a passenger vehicle 100 according to an example arrangement. FIG. 2 is a schematic view of a drivetrain system 120 of passenger vehicle 100. As shown in FIG. 1, passenger vehicle 100 is illustrated as a sedan. However, passenger vehicle 100 in FIG. 1 is provided as an example only. For instance, passenger vehicle 100 may be a coupe, a convertible, a truck, a van, a sports utility vehicle, etc. in alternative example arrangements. In addition, while described below in the context of passenger vehicle 100, it will be understood that the present subject matter may be used in or with any other suitable vehicles, including commercial vehicles, such as tractor-trailers, busses, box trucks, farm vehicles, construction vehicles, etc., in other example arrangements.

Passenger vehicle 100 may include a body 110 rolls on wheels 116 during driving of passenger vehicle 100. Body 110 that defines an interior cabin 112, and a driver and passengers may access interior cabin 112 via doors 114 and sit within interior cabin 112 on seats (not shown). Within body 110, passenger vehicle 100 may also include various systems, including a motor system 122, a transmission system 124, an electrical accumulator/storage system 126, etc., for operating passenger vehicle 100.

In general, motor system 122, transmission system 124, and electrical accumulator system 126 may be configured in any conventional manner. For example, motor system 122 may include prime movers, such as an electric machine system 140 and an internal combustion engine system 142 (FIG. 2), that are operatable to propel passenger vehicle 100. Thus, passenger vehicle 100 may be referred to as a hybrid vehicle. Motor system 122 may be disposed within body 110 and may be coupled to transmission system 124. Transmission system 124 is disposed within power flow between motor system 122 and wheels 116 of passenger vehicle 100. In certain example arrangements, a torque converter 128 may be disposed in the power flow between internal combustion engine system 142 and transmission system 124 within drivetrain system 120. Transmission system 124 is operative to provide various speed and torque ratios between an input and output of the transmission system 124. Thus, e.g., transmission system 124 may provide a mechanical advantage to assist propulsion of passenger vehicle 100 by motor system 122. A differential 129 may be provided between transmission system 124 and wheels 116 to couple transmission system 124 and wheels 116 while also allowing relative rotation between wheels 116 on opposite sides of body 110.

Electric machine system 140 may be selectively operable as either a motor to propel passenger vehicle 100 or as a generator to provide electrical power, e.g., to electrical accumulator system 126 and other electrical consumers of passenger vehicle 100. Thus, e.g., electric machine system 140 may operate as a motor in certain operating modes of passenger vehicle 100, and electric machine system 140 may operate as generator in other operating modes of passenger vehicle 100. Electric machine system 140 may disposed within drivetrain system 120 in various arrangements. For instance, electric machine system 140 may be provided as a module in the power flow path between internal combustion engine system 142 and transmission system 124. As another example, electric machine system 140 may be integrated within transmission system 124.

Electrical accumulator system 126 may include one or more batteries, capacitors, etc. for storing electrical energy. Electric machine system 140 is coupled to electrical accumulator system 126 and may be selectively operable to charge electrical accumulator system 126 when operating as a generator and to draw electrical power from electrical accumulator system 126 to propel passenger vehicle 100 when operating as a motor.

A braking system (not shown) is operable to decelerate passenger vehicle 100. For instance, the braking system may include friction brakes configured to selectively reduce the rotational velocity of wheels 116. The braking system may also be configured to as a regenerative braking system that converts kinetic energy of wheels 116 into electric current. Operation of motor system 122, transmission system 124, electrical accumulator system 126, and the braking system are well known to those skilled in the art and not described in extensive detail herein for the sake of brevity.

FIG. 3 is a schematic view of certain components of a control system 130 suitable for use with passenger vehicle 100. In general, control system 130 is configured to control operation of passenger vehicle 100 and components therein. Control system 130 may facilitate operation of passenger vehicle 100 in various operating modes. For instance, control system 130 may be configured to operate passenger vehicle 100 in any one of a conventional mode, an electric mode, a hybrid mode, and a regeneration mode. In the conventional mode, passenger vehicle 100 is propelled only by internal combustion engine system 142. Conversely, passenger vehicle 100 is propelled only by electrical machine system 140 in the electric mode. The conventional mode may provide passenger vehicle 100 with an extended operating range relative to the electric mode, and passenger vehicle 100 may be quickly refilled at a fueling station to allow continued operation of passenger vehicle 100 in the conventional mode. Conversely, the emissions of passenger vehicle 100 may be significantly reduced in the electric mode relative to the conventional mode, and a fuel efficiency of passenger vehicle 100 may increase significantly in the electric mode as compared to the conventional mode. In the hybrid mode, passenger vehicle 100 may be propelled by both electrical machine system 140 and internal combustion engine system 142. In the regeneration mode, electrical machine system 140 may charge electrical accumulator system 126, e.g., and internal combustion engine system 142 may propel passenger vehicle 100. The various operating modes of passenger vehicle 100 are well known to those skilled in the art and not described in extensive detail herein for the sake of brevity.

As shown in FIG. 3, control system 130 includes one or more computing devices 132 with one or more processors 134 and one or more memory devices 136 (hereinafter referred to as “memories 136”). In certain example arrangements, control system 130 may correspond to an electronic control unit (ECU) of passenger vehicle 100. The one or more memories 136 stores information accessible by the one or more processors 134, including instructions 138 that may be executed and data 139 usable by the one or more processors 134. The one or more memories 136 may be of any type capable of storing information accessible by the one or more processors 134, including a computing device-readable medium. The memory is a non-transitory medium, such as a hard-drive, memory card, optical disk, solid-state, tape memory, or the like. The one or more memories 136 may include different combinations of the foregoing, whereby different portions of the instructions and data are stored on different types of media. The one or more processor 134 may be any conventional processors, such as commercially available CPUs. Alternatively, the one or more processors 134 may be a dedicated device, such as an ASIC or other hardware-based processor.

Instructions 138 may be any set of instructions to be executed directly (such as machine code) or indirectly (such as scripts) by the one or more processors 134. For example, the instructions 138 may be stored as computing device code on the computing device-readable medium of the one or more memories 136. In that regard, the terms “instructions” and “programs” may be used interchangeably herein. Instructions 138 may be stored in object code format for direct processing by the processor or in any other computing device language, including scripts or collections of independent source code modules that are interpreted on demand or compiled in advance. Data 139 may be retrieved, stored, or modified by the one or more processors 134 in accordance with the instructions 138. For instance, data 139 of the one or more memories 136 may store information from sensors of various systems of passenger vehicle 100, including motor system 122 (e.g., electrical machine system 140 and internal combustion engine system 142), transmission system 124, electrical accumulator system 126, etc. In FIG. 3, the processor(s) 134, memory(ies) 136, and other elements of computing device(s) 132 are shown within the same block. However, computing device(s) 132 may actually include multiple processors, computing devices, and/or memories that may or may not be stored within a common physical housing. Similarly, the one or more memories 136 may be a hard drive or other storage media located in a housing different from that of the processor(s) 134. Accordingly, computing device(s) 132 will be understood to include a collection of processor(s) and one or more memories that may or may not operate in parallel.

Computing device(s) 132 may be configured for communicating with various components of passenger vehicle 100. For example, computing device(s) 132 may be in operative communication with various systems of passenger vehicle 100, including motor system 122 (e.g., electrical machine system 140 and internal combustion engine system 142), transmission system 124, electrical accumulator system 126, etc. For instance, computing device(s) 132 may be in operative communication with an engine control unit (ECU) (not shown) of motor system 122 and a transmission control unit (TCU) (not shown) of transmission system 124. Computing device(s) 132 may also be in operative communication with other systems of passenger vehicle 100, including a passenger/driver information system 150, e.g., that includes one or mode display(s), speaker(s), gauge(s), etc. within interior cabin 112 for providing information regarding operation of passenger vehicle 100 to a passenger/driver, a cabin environment system 152 for modifying the temperature of interior cabin 112, e.g., via air conditioning, heating, etc., a navigation system 154 for navigating passenger vehicle 100 to a destination, and/or a positioning system 156 for determining a current location (e.g., GPS coordinates) of passenger vehicle 100. Computing device(s) 132 may be configured to control system(s) 122, 124, 126 based at least in part on inputs received from an operator via a user interface (not shown), which may include one or more of a steering wheel, a gas pedal, a clutch pedal, a brake pedal, turn signal lever, hazard light switch, and/or the like.

Control system 130 may also include a wireless communication system 160 assists with wireless communication with other systems. For instance, wireless communication system 160 may wirelessly connect control system 130 with one or more other vehicles, buildings, etc. directly or via a communication network. Wireless communication system 160 may include an antenna and a chipset configured to communicate according to one or more wireless communication protocols, such as Bluetooth, communication protocols described in IEEE 802.11, GSM, CDMA, UMTS, EV-DO, WiMAX, LTE, Zigbee, dedicated short range communications (DSRC), radio frequency identification (RFID) communications, etc. It should be appreciated that the internal communication between the computing device(s) 132 and the system(s) 122, 124, 126, 140, 142 within passenger vehicle 100 may be wired and/or wireless. As an example, systems within passenger vehicle 100 may be connected and communicate via a CAN bus.

As shown in FIG. 1, passenger vehicle 100 may include a front camera 158 and a rear camera 159. Front camera 158 may be a component of an advanced driver assistance system (ADAS) of passenger vehicle 100. For example, front camera 158 may be oriented on body 110 along a forward direction of travel. Thus, front camera 158 may capture image(s) of an area in front of passenger vehicle 100 during travel. For instance, front camera 158 may capture image(s) of vehicles in front of passenger vehicle 100 during travel, and image(s) from front camera 158 may be utilized for adaptive cruise control, forward collision warning, etc. Rear camera 159 may be a backup camera for passenger vehicle 100. For example, rear camera 159 may be oriented on body 110 along a reverse direction of travel. Thus, rear camera 159 may capture image(s) of an area behind the passenger vehicle 100 during travel. For instance, rear camera 159 may capture image(s) of vehicles or pedestrians behind passenger vehicle 100 during travel, and image(s) from rear camera 159 may be presented on a display of driver information system 150 so that the driver of passenger vehicle 100 may utilize such images during reverse travel of passenger vehicle 100. Passenger vehicle 100 may also include other cameras, such as side view cameras to facilitate lane changes of the passenger vehicle 100.

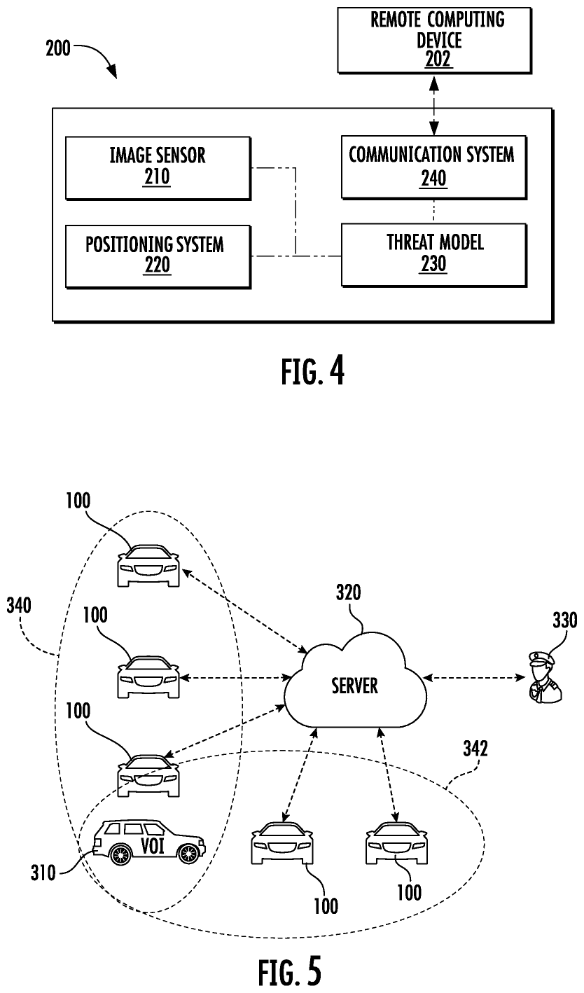

Turning now to FIGS. 4 and 5, the passenger vehicle 100 may also include features for detecting a vehicle of interest 310. Moreover, FIG. 4 is a block diagram of a process for a vehicle of interest identification system 200 of passenger vehicle 100 according to an example arrangement of the present subject matter, and FIG. 5 is a schematic view of passenger vehicles 100 using vehicle of interest identification systems 200 to identify and locate the vehicle of interest 310. As an example, the process of the vehicle of interest identification system 200 may be implemented on control system 130 via processors 134 such that process is performed at the edge or on passenger vehicle 100. Thus, as shown in FIG. 5, each of the passenger vehicles 100 may implement the vehicle of interest identification system 200 at the edge or on passenger vehicle 100.

The vehicle of interest identification system 200 of passenger vehicle 100 may assist a law enforcement agency 330 or other emergency service provider with identifying and locating the vehicle of interest 310. For instance, the law enforcement agency 330 or other emergency service provider may issue a vehicle of interest alert to facilitate an investigation, such as an amber alert or a criminal search. The vehicle of interest alert may include a description of the vehicle of interest 310, such as a make, a model, a color, a license plate number, number of passengers, and an age of passengers. The vehicle of interest identification system 200 may receive the vehicle of interest alert (and the description of the vehicle of interest 310) via a remote computing device 202. In example arrangements, the driver (or other operator or owner) of the passenger vehicle 100 may enroll or register the vehicle of interest identification system 200 to receive vehicle of interest alerts from the law enforcement agency 330 or other emergency service provider. As discussed in greater detail below, the vehicle of interest identification system 200 may be configured for identifying and locating the vehicle of interest 310 from among the various other vehicles that are located around the passenger vehicles 100.

With reference to FIG. 4, the vehicle of interest identification system 200 of passenger vehicle 100 may utilize images from sensors, such as one or more of the front camera 158, the rear camera 159, and/or a side-view camera to detect and identify vehicles of interest 310. Moreover, the vehicle of interest identification system 200 may utilize images of other vehicles to identify and locate the vehicle of interest 310 from among the various other vehicles around the passenger vehicle 100. When the vehicle of interest 310 is identified, the vehicle of interest identification system 200 may compute a vehicle of interest identification for transmission to the law enforcement agency 330 or other emergency services provider to assist with investigation of the vehicle of interest 310.

The vehicle of interest identification system 200 may be configured as part of the control system 130 of the passenger vehicle 100 in certain example arrangements. Thus, e.g., the computing devices 132 may be programmed to implement the vehicle of interest identification system 200 in certain example arrangements. It will be understood that the vehicle of interest identification system 200 may be used in or with any suitable vehicle. Thus, while described below in the context of the passenger vehicle 100, the vehicle of interest identification system 200 may be used in or with a car, a bus, a truck, a van, or any other vehicle that travels on a roadway. As noted above, the vehicle of interest identification system 200 may advantageously identify vehicles of interest based at least in part on images taken by sensors on the vehicle with the vehicle of interest identification system 200.

With reference to FIG. 4, the vehicle of interest identification system 200 may include or be communication with an image sensor 210, which is configured for generating data corresponding to images of one or more other vehicles around the passenger vehicle 100. As an example, the image sensor 210 may include one or more of a side-view camera, the front camera 158, rear camera 159. Thus, e.g., the images from the image sensor 210 may be a picture or video from the front camera 158, a picture or video from the rear camera 159, or a picture from the side-view camera. The vehicle of interest identification system 200 on the passenger vehicle 100 may thus access or receive data corresponding to images of other vehicles from the image sensor 210.

The vehicle of interest identification system 200 may also include a positioning system 220. The positioning system 220, which may correspond to the positioning system 156, may be configured for determining a current location (e.g., GPS coordinates) of the passenger vehicle 100. The positioning system 220 may be used to estimate a position of the vehicle of interest 310 when identified by the vehicle of interest identification system 200.

The vehicle of interest identification system 200 may also include a vehicle of interest identification model 230. The vehicle of interest identification model 230 may include a machine-learned model configured to identify vehicles of interest based at least in part on the images from the image sensor 210. As an example, the vehicle of interest identification model 230 may utilize convolutional neural networks or other machine-learning detection algorithms trained (e.g., supervised first and unsupervised later) to recognize, detect, or identify vehicles of interest in the images of the other vehicles from the image sensor 210. For instance, the vehicle of interest identification model 230 may compute a vehicle of interest match estimate for the other vehicles based on data from the image sensor 210. The vehicle of interest match estimate may correspond to a likelihood calculated by the machine-learned model that the other vehicle(s) correspond to the vehicle of interest 310.

The vehicle of interest identification model 230 may be trained using a training dataset determined using information describing previous vehicles. The training dataset may include one or more positive samples, with each positive sample representing a vehicle identification characteristic. The vehicle identification characteristic may include one or more of makes, models, colors, license plate numbers, numbers of passengers, and ages of passengers. Thus, the machine-learned model of the vehicle of interest identification model 230 may be trained to identify the characteristic of the other vehicle(s) in images from the image sensor 210.

The vehicle of interest identification model 230 may also compute a vehicle of interest identification for the other vehicle(s) around the passenger vehicle 100. Moreover, the vehicle of interest identification model 230 may compute the vehicle of interest identification, e.g., when the vehicle of interest identification model 230 identifies the vehicle of interest 310 from the images of the image sensor 210. The vehicle of interest identification may include one or more of a location of the vehicle of interest 310, a travel direction for the vehicle of interest 310, a speed of the vehicle of interest 310, and an image of the vehicle of interest 310.

The vehicle of interest identification model 230 may generate the vehicle of interest identification when the vehicle of interest match estimate for the other vehicle(s) exceeds a threshold value, which can be selected depending upon the desired match likelihood. The vehicle of interest match estimate may correspond to a calculated likelihood that one of the other vehicles around the passenger vehicle 100 corresponds to the vehicle of interest 310.

The vehicle of interest identification system 200 may also include features for transmitting the vehicle of interest identification to other computing devices located offboard the passenger vehicle 100. For example, the vehicle of interest identification system 200 may include a communication system 240 configured for transmitting data with other computing devices, such as a remote computing device 202 located separately from the passenger vehicle 100. In example arrangements, the communication system 240 may include or correspond to the wireless communication system 160. As an example, the remote computing device 202 may be a cloud server 320 (FIG. 5). The vehicle of interest identification system 200 may be configured for transmitting data corresponding to a vehicle of interest identification to the remote computing device 202, e.g., when the vehicle of interest identification model 230 identifies the potential match for the vehicle of interest 310 from the images of the image sensor 210, such as when the vehicle of interest match estimate for the other vehicle(s) exceeds the threshold value.

The remote computing device 202 may be configured for alerting the law enforcement agency 330 or other emergency service provider about the potential match for the vehicle of interest 310. Moreover, the remote computing device 202 may be configured to transmit data corresponding to one or more of the location of the vehicle of interest 310, the travel direction for the vehicle of interest 310, the speed of the vehicle of interest 310, and the image of the vehicle of interest 310 to the law enforcement agency 330 or other emergency service provider. Thus, the vehicle of interest identification system 200 may assist the law enforcement agency 330 or other emergency service provider by transmitting the location and other data related to the vehicle of interest 310 to the law enforcement agency 330 or other emergency service provider via the remote computing device 202. The law enforcement agency 330 or other emergency service provider may then investigate the vehicle of interest 310.

In example arrangements, the remote computing device 202 may be a cloud server. Thus, e.g., the communication system 240 may be configured for vehicle-to-infrastructure communication. In certain example arrangements, the remote computing device 202 may include one or more other passenger vehicles 100 with vehicle of interest identification systems 200. Thus, the communication system 240 may be configured for vehicle-to-vehicle communication. In such arrangements, the vehicle of interest identification systems 200 of the passenger vehicles 100 may be configured for coordinating observation of the vehicle of interest 310. For instance, one passenger vehicle 100 may hand off observation of the vehicle of interest 100 based upon the driving behavior of the vehicle of interest 310. Multiple passenger vehicles 100 may also collectively observe the vehicle of interest 310 to gather information about the vehicle of interest 310, e.g., which each passenger vehicle 100 could not gather individually.

In example arrangements, the vehicle of interest alerts may include a geofence 340 for the vehicle of interest 310. For instance, the law enforcement agency 330 or other emergency service provider may have a last known location and/or an estimated location for the vehicle of interest 310. The geofence 340 may correspond to an area around the last known location and/or an estimated location for the vehicle of interest 310, within which vehicle of interest identification systems 200 in the passenger vehicles 100 are activated to assist with identifying and locating the vehicle of interest 310. Thus, e.g., passenger vehicles 100 outside of the geofence 340 may be inactive and not assist with identifying and locating the vehicle of interest 310. The size, shape, orientation, and other features of the geofence 340 may be selected to facilitate the search of the vehicle of interest 310. For example, if the vehicle of interest 310 was last seen only a short time before the vehicle of interest alert, then the geofence 340 may be small. Conversely, if the vehicle of interest 310 was last seen a long time before the vehicle of interest alert, then the geofence 340 may be large. Similarly, if the vehicle of interest 310 is believed to be travelling fast, then the geofence 340 may be large. On the other hand, the geofence 340 may be small if the vehicle of interest 310 is believed to be travelling slowly.

As shown in FIG. 5, the geofence 340 may be shifted to an updated geofence 342. For example, one of the passenger vehicles 100 may identify and locate the vehicle of interest 310 within the original geofence 340, and the vehicle of interest alert may be updated with the updated geofence 342 to reflect the most recent information regarding the location of the vehicle of interest 310. It will be understood that the geofence 340, 342 may be repeatedly updated based upon the latest information regarding the vehicle of interest 310.

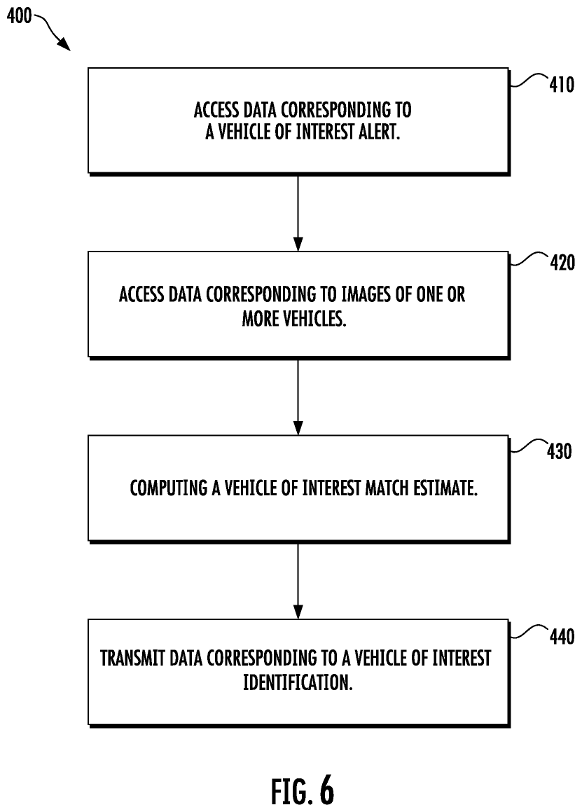

FIG. 6 is a flow diagram of a method 400 for vehicle of interest detection according to an example arrangement of the present subject matter. Method 400 will generally be described with reference to passenger vehicle 100 with front camera 158 and rear camera 159. For instance, method 400 may be at least partially executed by the vehicle of interest identification system 200. However, method 400 may be suitable for use with any other suitable type of vehicle, control system configuration, and/or vehicle system. In addition, although FIG. 6 depict steps performed in a particular order for purposes of illustration and discussion, the methods and algorithms discussed herein are not limited to any particular order or arrangement. One skilled in the art, using the disclosures provided herein, will appreciate that various steps of the methods and algorithms disclosed herein can be omitted, rearranged, combined, and/or adapted in various ways without deviating from the scope of the present disclosure.

At 410, data corresponding to a vehicle of interest alert may be accessed. For instance, the vehicle of interest identification system 200 may access the vehicle of interest alert at 410. The law enforcement agency 330 or other emergency service provider may generate the vehicle of interest alert along with the description of the vehicle of interest 310, such as a make, a model, a color, a license plate number, number of passengers, and an age of passengers. The law enforcement agency 330 or other emergency service provider may transmit the vehicle of interest alert, and passenger vehicles 100 may receive the vehicle of interest alert via the communication system 240 at 410. In example arrangements, the vehicle of interest identification system 200 may access the vehicle of interest alert when the passenger vehicle 100 is enrolled or registered to receive vehicle of interest alerts from the law enforcement agency 330 or other emergency service provider. In example arrangements, the vehicle of interest identification system 200 may access the vehicle of interest alert when the passenger vehicle 100 is located within the geofence 340. Conversely, the vehicle of interest identification system 200 may not access the vehicle of interest alert when the passenger vehicle 100 is located outside the geofence 340 and/or is not enrolled or registered to receive vehicle of interest alerts.

At 420, data corresponding to the images of one or more vehicles may be accessed. For example, an image sensor may capture an image of one or more vehicles near a vehicle at 420. Moreover, front camera 158, rear camera 159, and/or a side-view camera on the passenger vehicle 100 may capture images of one or more vehicles operating nearby the passenger vehicle 100 at 420. The control system 130 may access the data corresponding to the image(s) taken by the image sensors 210. For instance, the vehicle of interest identification model 230 may access the data corresponding to the image(s) taken by the front camera 158, rear camera 159, and/or a side-view camera at 410.

At 430, a vehicle of interest match estimate is computed based at least in part on the data corresponding to the images of one or more vehicles from 420. For example, the vehicle of interest identification model 230 may compute the vehicle of interest match estimate at 430 using data corresponding to the image(s) taken by front camera 158, rear camera 159, and/or a side-view camera at 420. The vehicle of interest identification model 230 may utilize a machine-learned model trained to identify the vehicle of interest 310 in the image(s) taken by the image sensor 210, and the machine-learned model may compute the vehicle of interest match estimate for the other vehicles in the image(s) taken by the image sensor 210. The vehicle of interest match estimate may correspond to a likelihood calculated by the machine-learned model that the other vehicle(s) around the passenger vehicle 100 match the vehicle of interest 310.

Method 400 may also include computing a vehicle of interest identification, e.g., with the vehicle of interest identification corresponding to characteristics of the potential match for the vehicle of interest 310. For instance, the vehicle of interest identification model 230 may compute the vehicle of interest identification with one or more of a location of the vehicle of interest 310, a travel direction for the vehicle of interest 310, a speed of the vehicle of interest 310, and an image of the vehicle of interest 310 at 440. In example arrangements, the vehicle of interest identification model 230 may compute the vehicle of interest identification when the vehicle of interest identification model 230 identifies the vehicle of interest 310 in the other vehicle(s) around the passenger vehicle 100 at 430. As noted above, the vehicle of interest identification model 230 may utilize the machine-learned model trained to identify vehicles of interest in the image(s) taken by the image sensor 210, such as the front camera 158, rear camera 159, and/or a side-view camera.

At 440, data corresponding to the vehicle of interest identification may be transmitted to a remote computing device. For example, the vehicle of interest identification system 200 may transmit data corresponding to the vehicle of interest identification to the remote computing device 202 via the communication system 240. The vehicle of interest identification system 200 may transmit the data corresponding to the vehicle of interest identification at 440, e.g., when the vehicle of interest identification model 230 identifies the potential match for the vehicle of interest 310 from the images of the image sensor 210.

Method 400 may also include alerting a law enforcement agency or other emergency service provider about the potential match for the vehicle of interest. For example, the remote computing device 202 may alert the law enforcement agency 330 or other emergency service provider about the potential match for the vehicle of interest 310. Moreover, the remote computing device 202 may transmit data corresponding to one or more locations of the vehicle of interest 310, the travel direction for the vehicle of interest 310, the speed of the vehicle of interest 310, and the image of the vehicle of interest 310 to the law enforcement agency 330 or other emergency service provider. The law enforcement agency 330 or other emergency service provider may then investigate the vehicle of interest 310.

As may be seen from the above, the present subject matter may provide systems and methods for identifying vehicle of interest, which can assist emergency service providers with locating the vehicle of interest. The vehicle of interest may be automatically identified by machine-learned models analyzing images from one or more onboard cameras. Participating vehicles may register to receive vehicle of interest alerts, and the vehicles may utilize system at the edge to identify the vehicle of interest among the various other vehicles around the participating vehicle. When detected, the vehicle may report the vehicle of interest to the emergency service provider. Participation of vehicles may also be determined by location, such as proximity to the vehicle of interest.

This written description uses examples to disclose the present subject matter and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

### Example Arrangements

First example arrangement: A method for identifying a vehicle of interest, comprising: accessing, with a computing device on a vehicle, data corresponding to a vehicle of interest alert; accessing, with the computing device, data from a sensor corresponding to images of one or more other vehicles; computing, with a machine-learned model on the computing device, a vehicle of interest match estimate for the one or more other vehicles based at least in part on the data from the sensor; computing, with the computing device, a vehicle of interest identification in response to the vehicle of interest match estimate exceeding a threshold level; and transmitting, with the computing device, data corresponding to the vehicle of interest identification to a remote computing device that is located outside the vehicle.

Second example arrangement: The method of the first example arrangement, wherein the vehicle of interest alert is issued by an emergency services agency.

Third example arrangement: The method of the first example arrangement or the second example arrangement, wherein the vehicle of interest alert comprises data corresponding to one or more of a make, a model, a color, and a license plate number for the vehicle of interest.

Fourth example arrangement: The method of any one of the first through third example arrangements, wherein the sensor comprises one or more of an advanced driver assistance system camera, a backup camera, and a sideview camera.

Fifth example arrangement: The method of any one of the first through fourth example arrangements, wherein the vehicle of interest match corresponds to a likelihood calculated by the machine-learned model that the one or more other vehicles matches the vehicle of interest.

Sixth example arrangement: The method of any one of the first through fifth example arrangements, wherein the machine-learned model has been trained using a training dataset determined using information describing previous vehicles, the training dataset comprising one or more positive samples, each positive sample representing a vehicle identification characteristic.

Seventh example arrangement: The method of any one of the first through sixth example arrangements, wherein the vehicle identification characteristic comprises one or more of a make, a model, a color, and a license plate number.

Eighth example arrangement: The method of any one of the first through seventh example arrangements, wherein the vehicle of interest identification comprises one or more of: a location of the vehicle of interest; a travel direction for the vehicle of interest; a speed of the vehicle of interest; and an image of the vehicle of interest.

Ninth example arrangement: The method of any one of the first through eighth example arrangements, wherein the remote computing device comprises a cloud server, the method further comprising transmitting, with the cloud server, the vehicle of interest identification to an emergency services agency.

Tenth example arrangement: The method of any one of the first through ninth example arrangements, further comprising computing, with the computing device, whether the vehicle is within a geofence for the vehicle of interest alert, wherein accessing the data from the sensor comprises accessing the data from the sensor when the vehicle is within the geofence.

Eleventh example arrangement: The method of any one of the first through tenth example arrangements, further comprising: accessing, with the computing device, data corresponding to an updated vehicle of interest alert; computing, with the computing device, whether the vehicle is within an updated geofence for the updated vehicle of interest alert; and continuing to access the data from the sensor when the vehicle is within the updated geofence.

Twelfth example arrangement: The method of any one of the first through eleventh example arrangements, further comprising terminating the computing of the vehicle of interest match estimate when the vehicle is outside of the geofence.

Thirteenth example arrangement: A system for identifying a vehicle of interest includes: a vehicle; a sensor located on the vehicle; one or more processors located onboard the vehicle; and one or more non-transitory computer-readable media that store instructions that are executable by the one or more processors to perform operations. The operations include: accessing data corresponding to a vehicle of interest alert, accessing data from the sensor corresponding to images of one or more other vehicles; computing, with a machine-learned model, a vehicle of interest match estimate for the one or more other vehicles based at least in part on the data from the sensor; computing a vehicle of interest identification in response to the vehicle of interest match estimate exceeding a threshold level; and transmitting data corresponding to the vehicle of interest identification to a remote computing device that is located outside the vehicle.

Fourteenth example arrangement: The system of the thirteenth example arrangement, wherein the vehicle of interest alert comprises data corresponding to one or more of a make, a model, a color, and a license plate number for the vehicle of interest.

Fifteenth example arrangement: The system of either of the thirteenth or fourteenth example arrangements, wherein the sensor comprises one or more of an advanced driver assistance system camera, a backup camera, and a sideview camera.

Sixteenth example arrangement: The system of any one of the thirteenth through fifteenth example arrangements, the vehicle of interest match corresponds to a likelihood calculated by the machine-learned model that the one or more other vehicles matches the vehicle of interest.

Seventeenth example arrangement: The system of any one of the thirteenth through sixteenth example arrangements, wherein the vehicle of interest identification comprises one or more of: a location of the vehicle of interest; a travel direction for the vehicle of interest; a speed of the vehicle of interest; and an image of the vehicle of interest.

Eighteenth example arrangement: The system of any one of the thirteenth through seventeenth example arrangements, wherein the operations comprise computing whether the vehicle is within a geofence for the vehicle of interest alert, wherein accessing the data from the sensor comprises accessing the data from the sensor when the vehicle is within the geofence.

Nineteenth example arrangement: The system of any one of the thirteenth through eighteenth example arrangements, wherein the operations comprise: accessing data corresponding to an updated vehicle of interest alert; computing whether the vehicle is within an updated geofence for the updated vehicle of interest alert; and continuing to access the data from the sensor when the vehicle is within the updated geofence.

Twentieth example arrangement: The system of any one of the thirteenth through nineteenth example arrangements, wherein the operations comprise terminating the computing of the vehicle of interest match estimate when the vehicle is outside of the geofence.

What is claimed is:

1. A method for identifying a vehicle of interest, comprising:
accessing, with a computing device on a vehicle, data corresponding to a vehicle of interest alert;
accessing, with the computing device, data from a sensor corresponding to images of one or more other vehicles;
computing, with a machine-learned model on the computing device, a vehicle of interest match estimate for the one or more other vehicles based at least in part on the data from the sensor;
computing, with the computing device, a vehicle of interest identification in response to the vehicle of interest match estimate exceeding a threshold level; and
transmitting, with the computing device, data corresponding to the vehicle of interest identification to a remote computing device that is located outside the vehicle.

2. The method of claim 1, wherein the vehicle of interest alert is issued by an emergency services agency.

3. The method of claim 1, wherein the vehicle of interest alert comprises data corresponding to one or more of a make, a model, a color, and a license plate number for the vehicle of interest.

4. The method of claim 1, wherein the sensor comprises one or more of an advanced driver assistance system camera, a backup camera, and a sideview camera.

5. The method of claim 1, wherein the vehicle of interest match corresponds to a likelihood calculated by the machine-learned model that the one or more other vehicles matches the vehicle of interest.

6. The method of claim 1, wherein the machine-learned model has been trained using a training dataset determined using information describing previous vehicles, the training dataset comprising one or more positive samples, each positive sample representing a vehicle identification characteristic.

7. The method of claim 6, wherein the vehicle identification characteristic comprises one or more of a make, a model, a color, and a license plate number.

8. The method of claim 1, wherein the vehicle of interest identification comprises one or more of:
a location of the vehicle of interest;
a travel direction for the vehicle of interest;
a speed of the vehicle of interest; and
an image of the vehicle of interest.

9. The method of claim 1, wherein the remote computing device comprises a cloud server, the method further comprising transmitting, with the cloud server, the vehicle of interest identification to an emergency services agency.

10. The method of claim 1, further comprising computing, with the computing device, whether the vehicle is within a geofence for the vehicle of interest alert, wherein accessing the data from the sensor comprises accessing the data from the sensor when the vehicle is within the geofence.

11. The method of claim 10, further comprising:
accessing, with the computing device, data corresponding to an updated vehicle of interest alert;
computing, with the computing device, whether the vehicle is within an updated geofence for the updated vehicle of interest alert; and
continuing to access the data from the sensor when the vehicle is within the updated geofence.

12. The method of claim 10, further comprising terminating the computing of the vehicle of interest match estimate when the vehicle is outside of the geofence.

13. A system for identifying a vehicle of interest, comprising:
a vehicle;
a sensor located on the vehicle;
one or more processors located onboard the vehicle; and
one or more non-transitory computer-readable media that store instructions that are executable by the one or more processors to perform operations, the operations comprising
accessing data corresponding to a vehicle of interest alert,
accessing data from the sensor corresponding to images of one or more other vehicles,
computing, with a machine-learned model, a vehicle of interest match estimate for the one or more other vehicles based at least in part on the data from the sensor,
computing a vehicle of interest identification in response to the vehicle of interest match estimate exceeding a threshold level, and
transmitting data corresponding to the vehicle of interest identification to a remote computing device that is located outside the vehicle.

14. The system of claim 13, wherein the vehicle of interest alert comprises data corresponding to one or more of a make, a model, a color, and a license plate number for the vehicle of interest.

15. The system of claim 13, wherein the sensor comprises one or more of an advanced driver assistance system camera, a backup camera, and a sideview camera.

16. The system of claim 13, wherein the vehicle of interest match corresponds to a likelihood calculated by the machine-learned model that the one or more other vehicles matches the vehicle of interest.

17. The system of claim 13, wherein the vehicle of interest identification comprises one or more of:
a location of the vehicle of interest;
a travel direction for the vehicle of interest;
a speed of the vehicle of interest; and
an image of the vehicle of interest.

18. The system of claim 13, wherein the operations comprise computing whether the vehicle is within a geofence for the vehicle of interest alert, wherein accessing the data from the sensor comprises accessing the data from the sensor when the vehicle is within the geofence.

19. The system of claim 18, wherein the operations comprise:
accessing data corresponding to an updated vehicle of interest alert;
computing whether the vehicle is within an updated geofence for the updated vehicle of interest alert; and
continuing to access the data from the sensor when the vehicle is within the updated geofence.

20. The system of claim 18, wherein the operations comprise terminating the computing of the vehicle of interest match estimate when the vehicle is outside of the geofence.
